(19) United States
(12) Patent Application Publication
(10) Pub. No.: US 2014/0119865 A1
(43) Pub. Date: May 1, 2014

(54) WORKPIECE PICK-UP AND POSITIONING DEVICE

(71) Applicants: HON HAI PRECISION INDUSTRY CO., LTD., New Taipei (TW); Fu Tai Hua Industry (Shenzhen) Co., Ltd., Shenzhen (CN)

(72) Inventors: QING-HUA CHEN, Shenzhen (CN); BIN-BIN LEI, Shenzhen (CN); WEN-TAO LIAO, Shenzhen (CN)

(21) Appl. No.: 13/924,359

(22) Filed: Jun. 21, 2013

(30) Foreign Application Priority Data
Oct. 30, 2012 (CN) 2012104227890

(51) Int. Cl. B32B 38/18

(52) U.S. Cl. CPC B32B 38/18
USPC 414/590

(57) ABSTRACT

A device for picking up and positioning small pieces of adhesive tapes is provided. The device includes a number of suction members for picking up the adhesive tapes. The device further includes a driving unit to drive the suction members to move to various positions by turn, thereby positioning the adhesive tapes to various positions by turn.

### BACKGROUND

1. Technical Field

The present disclosure relates to a workpiece pick-up and positioning device for picking up and positioning small objects.

2. Description of Related Art

Small pieces of adhesive tape are widely used in many portable electronic devices, such as, mobile phones and tablet computers. For mass production of the portable electronic devices, it is desirable to provide a workpiece pick-up and positioning device for picking up and positioning the small pieces of adhesive tape.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a workpiece pick-up and positioning device according to one embodiment.

FIG. 2 is an isometric exploded view of the device of FIG. 1.

FIG. 3 is similar to FIG. 2, but viewed from a different view point.

FIG. 4 is an isometric exploded view of the device of FIG. 1, viewed from a different view point and showing more details.

FIGS. 5 and 6 are isometric exploded views of the device of FIG. 1, showing the device of FIG. 1 in a standby state.

FIGS. 7 and 8 are isometric exploded views of the device of FIG. 1, showing a first suction member in a desired position.

FIGS. 9 and 10 are isometric exploded views of the device of FIG. 1, showing a second suction member in a desired position.

### DETAILED DESCRIPTION

Embodiments of the present disclosure will be described with reference to the accompanying drawings.

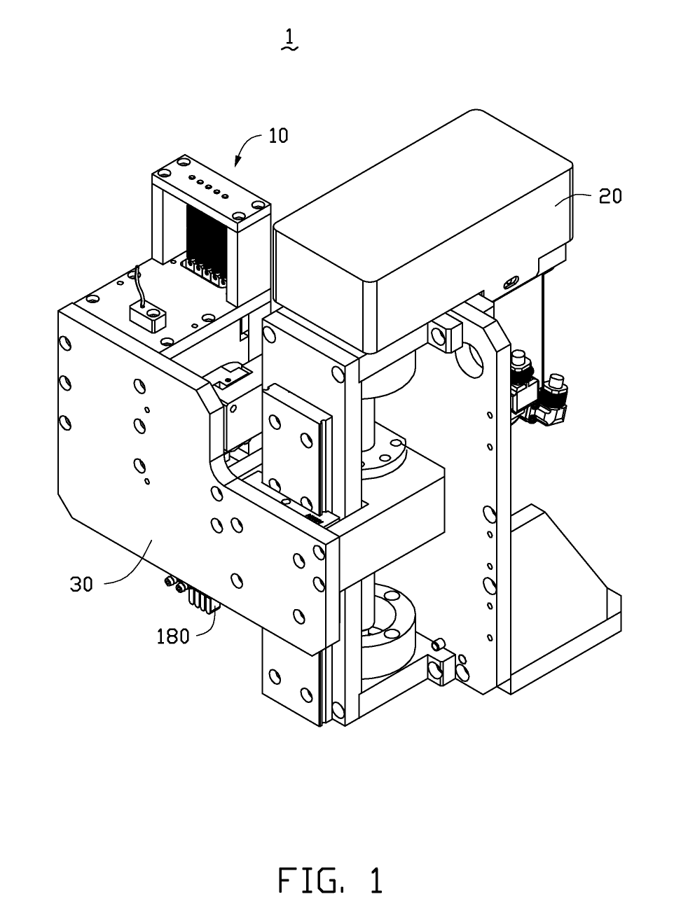

Referring to FIG. 1, a workpiece pick-up and positioning device 1 includes a pick-up unit 10, a driving unit 20, and a connection board 30. The pick-up unit 10 includes a number of suction members 180 for picking up workpieces (e.g., small pieces of adhesive tapes). The pick-up unit 10 and the driving unit 20 are connected together by the connection board 30. The driving unit 20 is used to drive the pick-up unit 10 to move up and down.

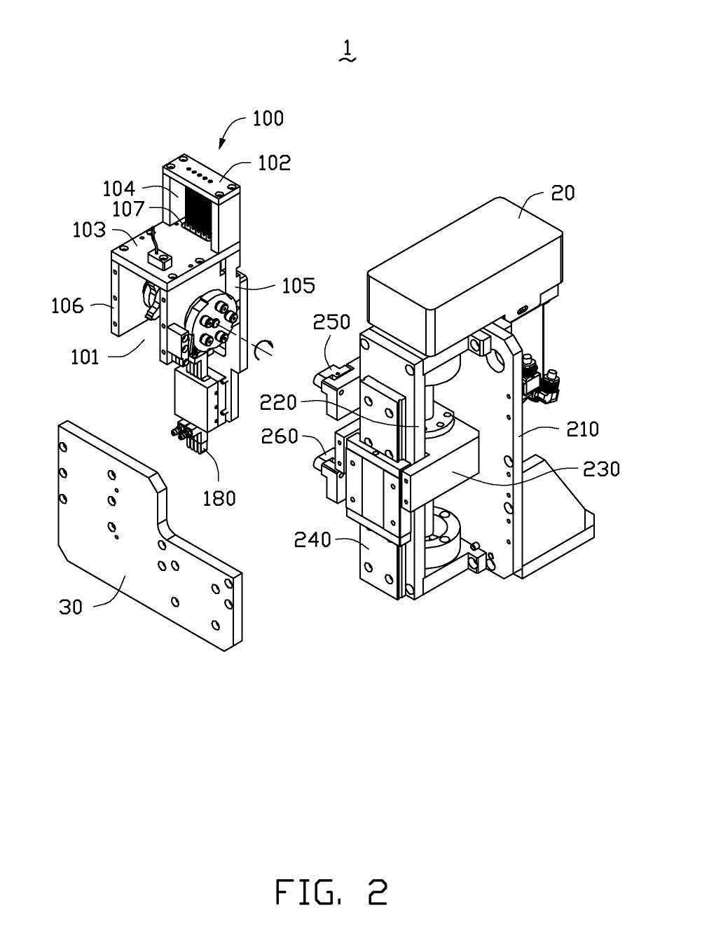

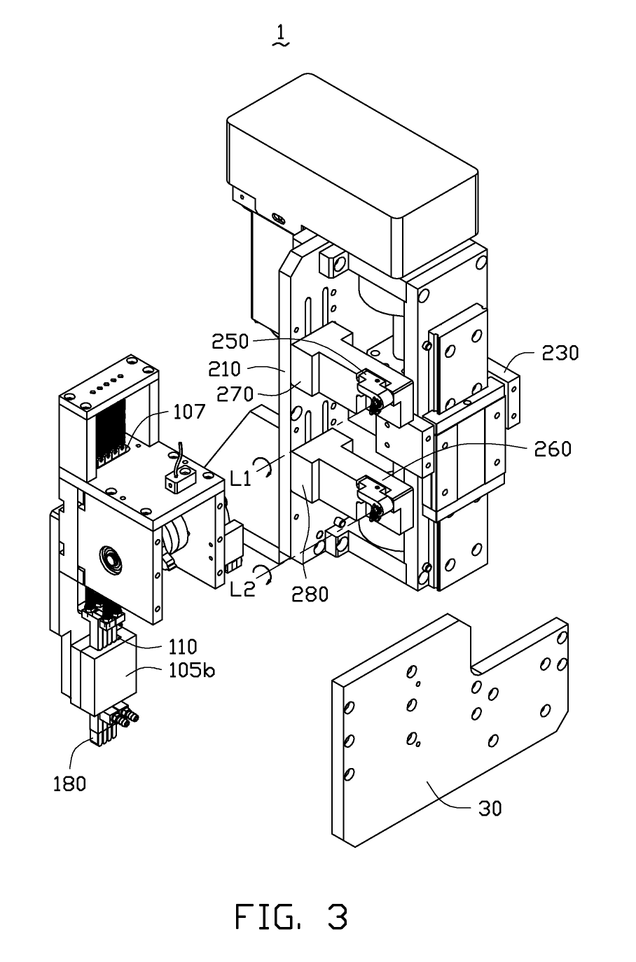

Referring to FIG. 2, the driving unit 20 includes a frame having a first vertical wall 210 and a second vertical wall 220, and a linear motor 240 secured to the second vertical wall 220. The linear motor 240 includes a movable member 230 that is slidable along the heightwise direction of the first vertical wall 210. The connection board 30 is secured to the movable member 230. Referring to FIG. 3, the driving unit 20 further includes a first block 270 and a second block 280 secured to the first vertical wall 210. The first block 270 includes a rotatable member 250 unidirectionally rotatably connected to its end. The second block 280 includes a rotatable member 260 unidirectionally rotatably connected to its end. The rotatable member 250 is able to rotate about an imaginary line L1 in the direction as indicated by the arrow A, and cannot rotate in the reverse direction. The rotatable member 260 is able to rotate about an imaginary line L2 in the direction as indicated by the arrow B, and cannot rotate in the reverse direction.

The imaginary lines L1 and L2 are perpendicular to the sliding direction of the movable member 230 of the driving unit 20.

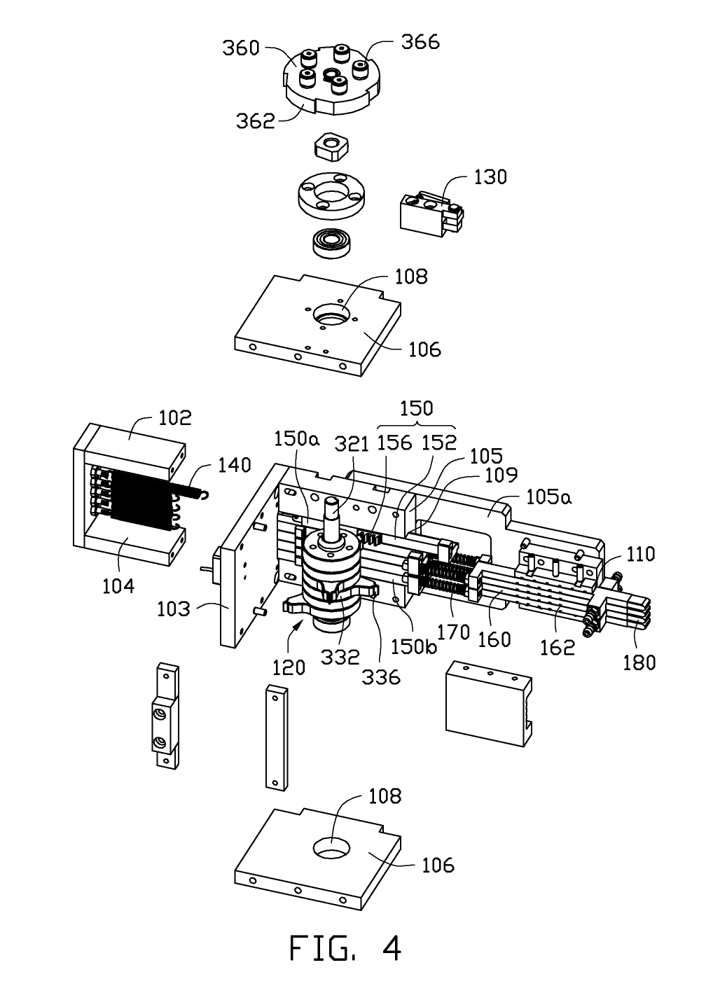

Referring to FIG. 4, the pick-up unit 10 further includes a frame 100 (FIG. 2), a transmission member 120, a pawl 130, a number of spring members 140, a number of racks 150, a number of sliders 160, and a number of resilient members 170. The frame 100 is secured to the connection board 30, and can move together with the connection board 30. The frame 100 includes a spring receiving portion 102, a cover plate 103, a first back plate 105, a second back plate 105a, and two side plates 106. The spring receiving portion 102 is secured to the top surface of the cover plate 103, and the cover plate 103 is secured to the top end of the first back plate 105. The two side plates 106 are secured to the front surface of the first back plate 105 at opposite sides. Each side plate 106 defines a through hole 108.

The two side plates 106, the first back plate 105 and the cover plate 103 cooperatively define a receiving space 101 (FIG. 2). The cover plate 103 and the spring receiving portion 102 cooperatively define a chamber 104 (FIG. 2) where the spring members 140 are received. The first back plate 105 defines a groove 109 in its front surface and the racks 150 are slidably received in the groove 109. The cover plate 103 defines an opening 107 that communicates with the groove 109 and the chamber 104, and lower ends of the spring members 140 pass through the opening 107 and are connected to the top ends of the racks 150. The second back plate 105a is secured to the back surface of the first back plate 105, and includes a guiding member 105b (FIG. 3) that defines a guiding groove 110 (FIG. 3) for the extension of the sliders 160.

The racks 150 are arranged side by side in the groove 109. Each rack 150 includes a body 152 and a number of teeth 156 formed on the body 152. The top end of each rack 150 is secured to the lower end of one spring member 140. In the embodiment, one rack 150 (hereinafter referred to as “rack 150a”) is not connected to any of resilient members 170, and each of the rest of the racks 150 (hereinafter referred to as “racks 150b”) is connected to the top end of one resilient member 170. The spring members 140 are used to apply a pulling force to the rack 150a and the racks 150b. In the embodiment, the spring members 140 are coil springs. The lower ends of the resilient members 170 are secured to the top ends of the sliders 160. The suction members 180 are secured to the lower ends of the sliders 160. In the embodiment, a number of rolling pins 162 are arranged between each two adjacent sliders 160. The rolling pins 162 can roll between two adjacent sliders 160, which allow one slider 160 to slide with respect to its adjacent slider(s) 160, without causing the adjacent slider(s) 160 to move.

The transmission member 120 includes a shaft 321, a number of discs 332 secured to the shaft 321, and a ratchet 360. The shaft 321 is rotatably connected to side plates 106 via bearings received in the holes 108. The discs 332 are located within the receiving space 101, and each includes a tooth 336 projecting from its circumferential surface. The teeth 336 are equisangularly spaced and arranged around the shaft 321. That is, in case there are five discs 332 in the embodiment, each two adjacent teeth 336 are spaced apart from each other by 72 degrees. The discs 332 are able to rotate together with the shaft 321, thereby causing the teeth 336 to be engaged with the racks 150 in turn. The resilient members 170 then push the sliders 160 in turn, thereby causing the suction members 180 to move in turn. When one of the teeth 336 disengages from the corresponding rack 150, the corresponding rack 150 returns to its original position as pulled by the corresponding spring member 140, thereby causing the corresponding suction member 180 to return to its original position.

The ratchet 360 is secured to an outer side of one of the side plates 106, and is positioned between the one of the slide plates 106 and the driving unit 20. The ratchet 360 is secured to one end of the shaft 321, and thus able to rotate together with the shaft 321. The ratchet 360 includes a number of teeth 362 on its lateral surface, and a number of protruding members 366 protruding from its side surface that faces the driving unit 20.

The teeth 362 are evenly arranged on the lateral surface of the ratchet 360, and the number of the teeth 362 is equal to the number of the teeth 336 of the discs 332. The protruding members 366 are evenly arranged on the side surface of the ratchet 360, and the number of the protruding members 366 equals to the number of the teeth 362. In the embodiment, the protruding members 366 are rollers.

The pawl 130 is secured to the outer side of the side plate 106 where the ratchet 360 is located. The pawl 130 is used to be engaged with the teeth 362 of the ratchet 360, such that the ratchet 360 can rotate only in the direction as indicated by the arrow C shown in FIG. 2, and cannot rotate in the reverse direction.

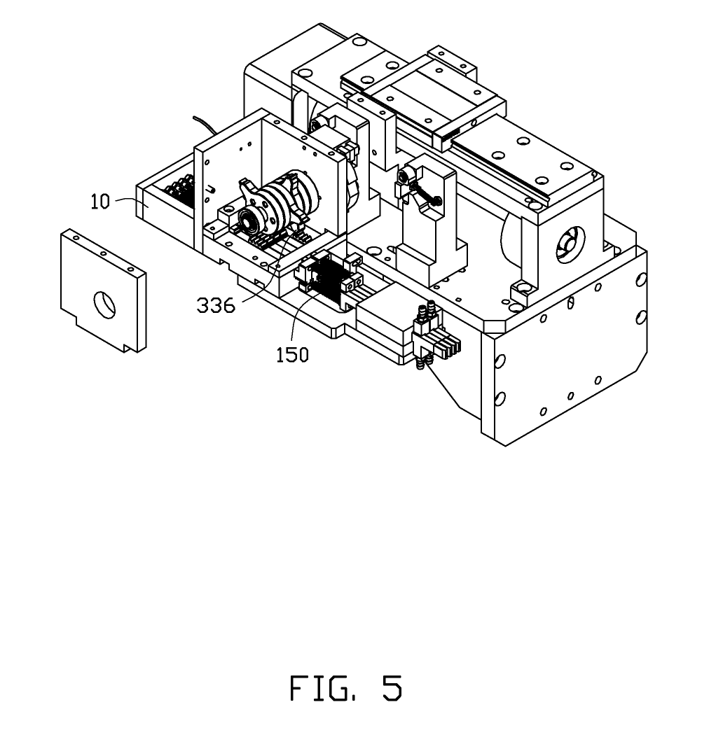

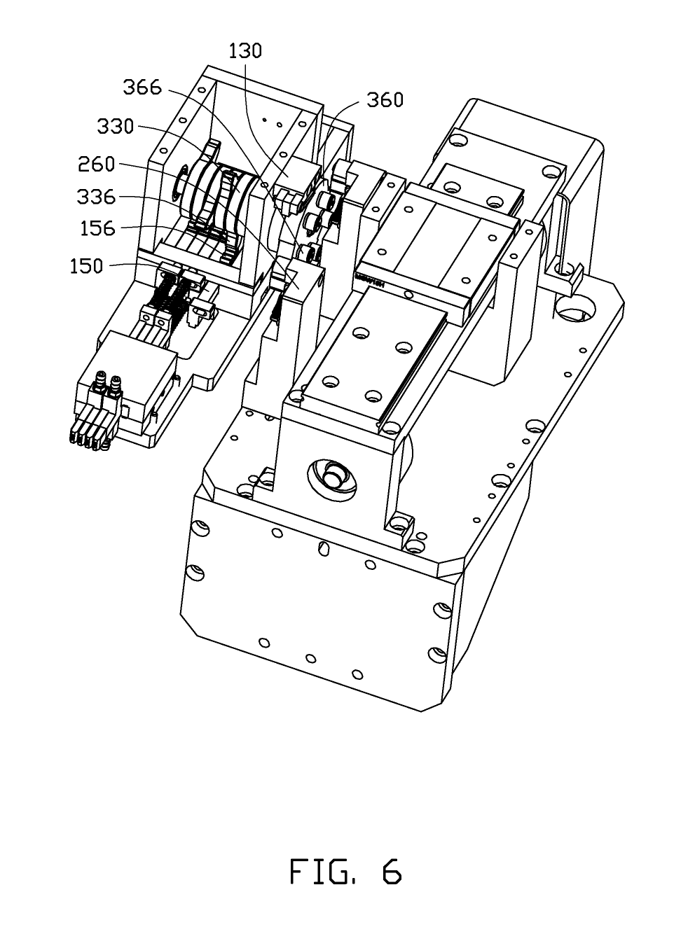

FIGS. 1 and 5-6 show the workpiece pick-up and positioning device 1 in a standby state. The ratchet 360 is located between the rotatable members 250 and 260. The pick-up unit 10 is first driven to move down to pick up workpieces. In the embodiment, the movable member 230 moves down, and the pick-up unit 10 moves together with the movable member 230. During the moving of the pick-up unit 10, one of the protruding members 366 of the ratchet 360 will contact the rotatable member 260, and the engagement of the protruding member 366 and the rotatable member 260 provides a torque to the ratchet 360. The ratchet 360 then rotates, causing the shaft 321 to rotate together with the ratchet 360. The rack 150a is then engaged with the corresponding teeth 336 of one disc 332. After the pick-up unit 10 moves to a preset position where the suction members 180 are right above the workpieces, a vacuum generator (not shown) is started, which causes the suction members 180 to pick up the workpieces by suction force. After that, the movable member 230 starts to move upward, causing the pick-up unit 10 to move upward. During the moving of the pick-up unit 10, another one of the protruding members 366 under the rotatable member 260 will contact the rotatable member 260. Since the pawl 130 is now engaged with one of the teeth 362, the torque generated due to the engagement of the protruding member 366 and the rotatable member 260 cannot turn the ratchet 360. The rotatable member 260 rotates as pushed by the protruding member 366 until the protruding member 366 is positioned above the rotatable member 260 and disengages from the rotatable member 260.

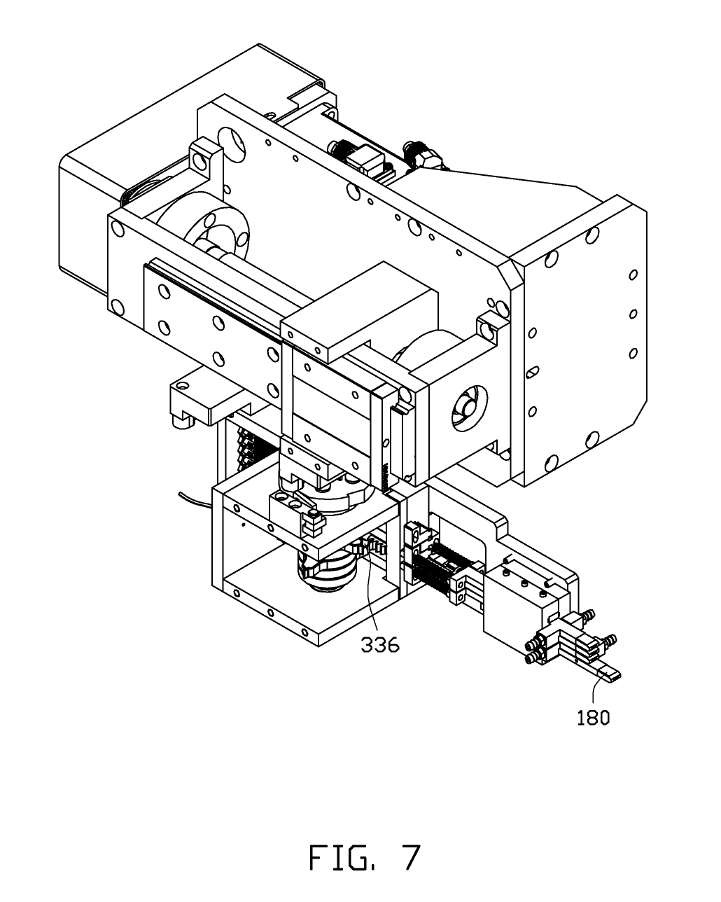

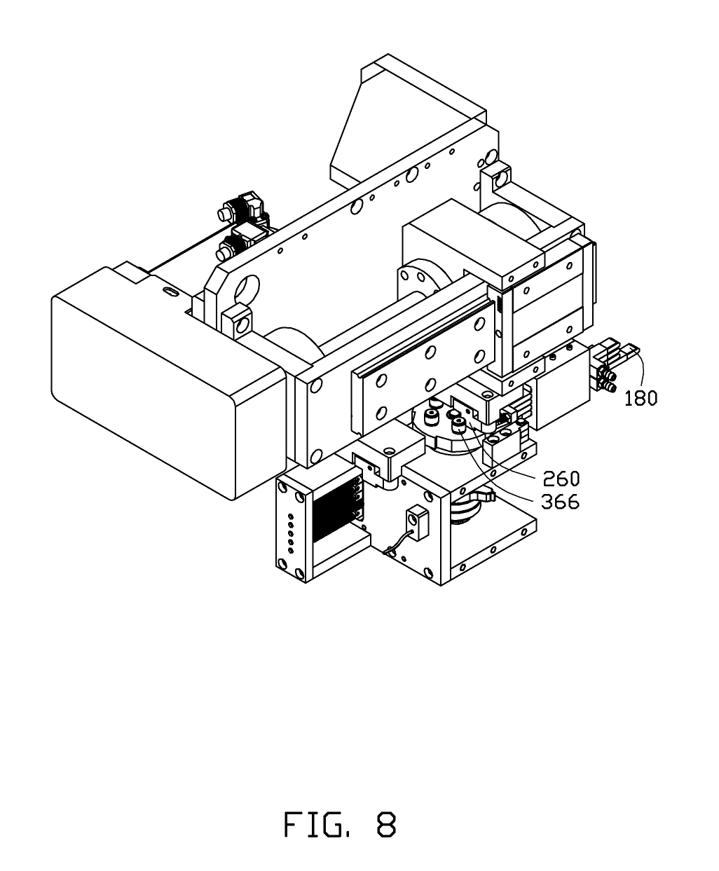

After the pick-up unit 10 returns to its original position, the movable member 230 stops. The pick-up unit 10 is then driven to move up and down repeatedly to cause the suction members 180 to move to a predetermined position one by one, such that the workpieces can be positioned to various positions in turn. Specifically, referring to FIGS. 7 and 8, the movable member 230 moves down again, and the pick-up unit 10 moves together with the moveable member 230. During the movement of the pick-up unit 10, one of the protruding members 366 of the ratchet 360 will contact the rotatable member 260, and the engagement of the protruding member 366 and the rotatable member 260 provides a torque to the ratchet 360. The ratchet 360 then rotates, causing the shaft 321 to rotate together with the ratchet 360.

During the rotation of the ratchet 360, the tooth 332 previously engaged with the rack 150a disengages from the rack 150a, and another tooth 332 engages with one of the racks 150b. The rack 150a then returns to its original position as pulled by the corresponding spring member 140. The rack 150b then slides with respect to the other racks 150b as driven by the teeth 332. After the pick-up unit 10 moves to a preset position, one of the suction members 180 has slid with respect to the other suction members 180 to a desired position. Then the suction member 180 is caused to release its workpiece. That is, in the embodiment, one piece of adhesive tape is applied to the desired position.

After that, the movable member 230 starts to move upward, causing the pick-up unit 10 to move upward. During the movement of the pick-up unit 10, another protruding member 366 under the rotatable member 260 will contact the rotatable member 260. Since the pawl 130 is now engaged with one of the teeth 362, the torque generated due to the engagement of the protruding member 366 and the rotatable member 260 cannot turn the ratchet 360. The rotatable member 260 rotates as pushed by the protruding member 366 until the protruding member 366 is located above the rotatable member 260 and disengages from the rotatable member 260.

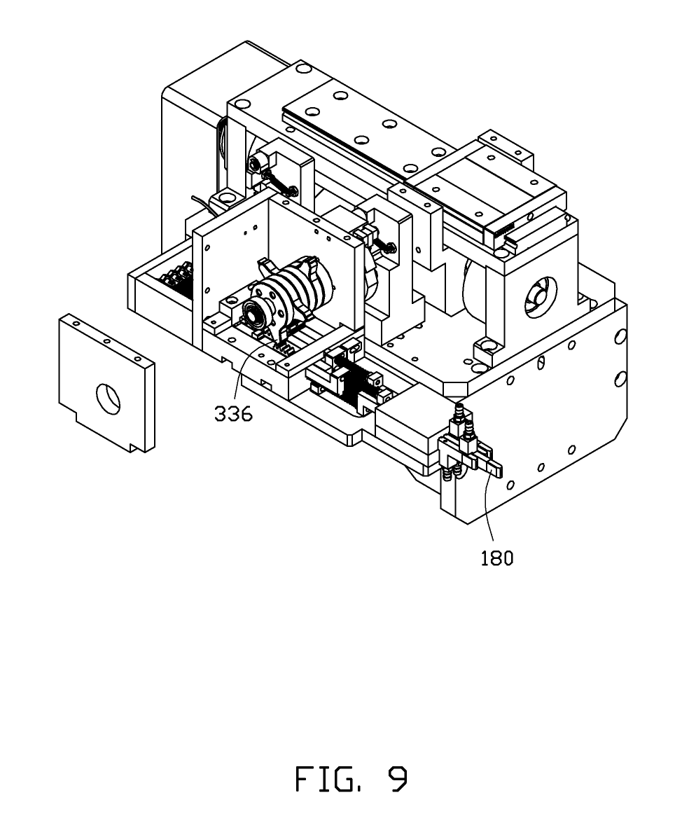

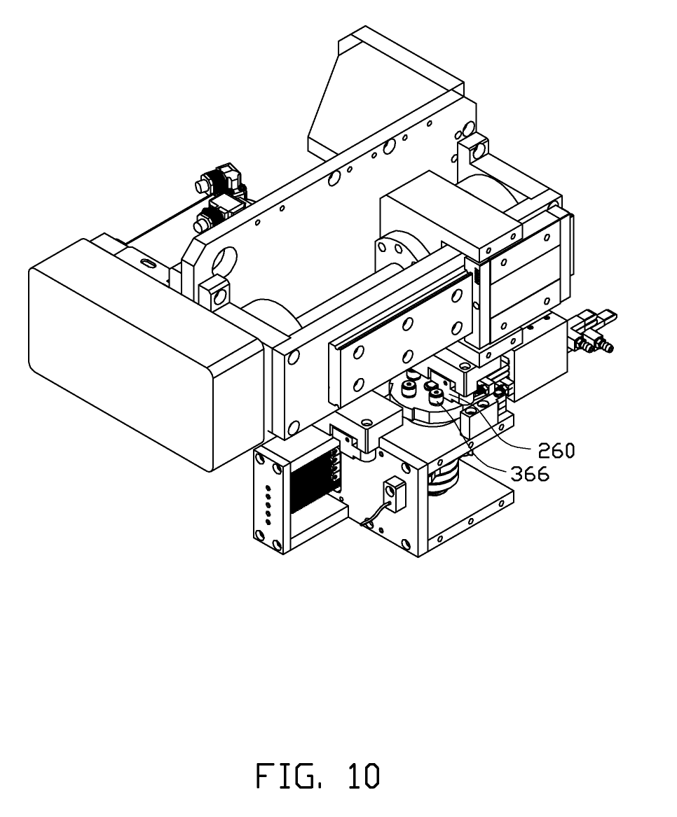

After the first workpiece has been properly positioned, the moveable member 230 can be controlled to move up and down again. During the movement of the movable member 230, the tooth 332 previously engaged with the rack 150b disengages from the rack 150b, and another tooth 332 will be engaged with another one of the racks 150b. The former rack 150b then returns to its original position as pulled by the corresponding spring member 140, and the latter rack 150b will repeat the movement of the previous rack 150b as described above, thereby causing another suction member 180 to be located at a desired position (FIGS. 9 and 10). A second workpiece is then located at the desired position after the suction member 180 releases the workpiece.

By repeating the process described in paragraph 0022, the third and fourth workpieces can be positioned at desired positions. In the embodiment, the resilient members 170 are used to provide proper pressure to the adhesive tapes, such that the adhesive tapes can be applied to desired positions firmly.

It is noted that the number of the suction members 180 can be varied according to need. The number of the sliders 160 is the same with the number of the suction members 180. The numbers of the spring 140, the racks 150, the discs 332, the teeth 362, and the protruding members 366 are the same. The number of the racks 150 is one more than the sliders 160.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. A workpiece pickup and positioning device comprising:
a first frame;
a driving device secured to the first frame;
a rotatable member unidirectionally rotatably connected to the first frame;
a second frame;
a connecting member connecting the second frame to the driving device;
a shaft rotatably connected to the second frame;
a plurality of discs secured to the shaft, each of the plurality of discs comprising a tooth projecting from a circumferential surface thereof, the teeth of the plurality of discs being equisangularly spaced and arranged around the shaft;
a ratchet secured to the shaft and comprising a plurality of teeth on a circumferential surface thereof and a plurality of protruding members protruding form a side surface thereof, the plurality of teeth of the ratchet being equisangularly spaced and arranged around the shaft, the plurality of protruding members being equidistantly spaced and arranged around the shaft, wherein one of the plurality of the protruding members is configured to contact the rotatable member when the second frame member moves from a first position to a second position, thereby causing the ratchet to rotate a predetermined angle;
a plurality of spring members;
a plurality of first racks and one second rack, each of the plurality of the first racks and the second rack being connected to the second frame via the corresponding spring member, the spring members being configured to provide a pulling force to the first racks and the second rack, the first racks and the second rack being slidable with respect to the second frame;
a plurality of sliding bars slidably connected to the second frame, each of the plurality of sliding bars comprising a first end connected to one of the plurality of first racks;
a plurality of suction members configured to pick up workpieces, each of the plurality of suction members being secured to a second end of one of the plurality of sliding bars; and
a pawl rotatably connected to the second frame and configured to engage with the plurality of teeth of the ratchet, the pawl being configured to engage with one of the plurality of teeth when the second frame member slides from the second position to the first position , thereby preventing the ratchet from rotating;
wherein the driving device is configured to drive the second frame to reciprocate, the ratchet is configured to rotate the predetermined angle during each reciprocation cycle of the second frame, causing a first one of the teeth of the discs to engage with a first one of the first racks and the second rack, and causing a second one of the teeth of the discs to disengage from a second one of the first racks and the second rack.

2. The workpiece pickup and positioning device according to claim 1, wherein each of the plurality of sliding bars is connected to the one of the plurality of first racks via a resilient member.

3. The workpiece pickup and positioning device according to claim 1, further comprising a plurality of rolling pins arranged between each two adjacent sliding bars.

4. The workpiece pickup and positioning device according to claim 1, wherein the driving device comprises a movable member that is movable along a heightwise direction of the first frame, and the second frame is secured to the movable member.

5. The workpiece pickup and positioning device according to claim 1, wherein the spring members are coil springs.

6. The workpiece pickup and positioning device according to claim 4, wherein the rotatable member is rotatable about an imaginary line that is perpendicular to a sliding direction of the movable member.
